(19) United States
(12) Patent Application Publication
(10) Pub. No.: US 2016/0077860 A1
(43) Pub. Date: Mar. 17, 2016

(54) VIRTUAL MACHINE PLACEMENT DETERMINATION DEVICE, VIRTUAL MACHINE PLACEMENT DETERMINATION METHOD, AND VIRTUAL MACHINE PLACEMENT DETERMINATION PROGRAM

(71) Applicant: NCE CORPORATION, Tokyo (JP)

(72) Inventor: Fumio MACHIDA, Tokyo (JP)

(21) Appl. No.: 14/787,510

(22) PCT Filed: Mar. 26, 2014
(86) PCT No.: PCT/JP2014/001746

§ 371 Date: Oct. 28, 2015

(30) Foreign Application Priority Data
May 9, 2013 (JP) 2013-099492

(51) Int. Cl. G06F 9/455; G06F 9/50

(52) U.S. Cl. CPC G06F 9/45558; G06F 9/5077; G06F 2009/4557

(57) ABSTRACT

The virtual machine placement determination device includes a virtual machine placement proposal search unit 1 configured to search for a virtual machine placement proposal satisfying resource limitation to enumerate; an availability model synthesizing unit 2 configured to reflect a configuration of an application on each virtual machine placement proposal to generate an availability model for obtaining availability indicating a probability that the application is in an activation state; an application availability evaluation unit 3 configured to analyze the availability model to calculate an availability evaluation value indicating the availability of an application system constructed by the virtual machine placement proposal; and a virtual machine placement ranking unit 4 configured to rank each virtual machine placement proposal based on the availability evaluation value to determine the virtual machine placement proposal applied to the application.

### TECHNICAL FIELD

The present invention relates to a virtual machine placement determination device, a virtual machine placement determination method, and a virtual machine placement determination program, in particular relates to a virtual machine placement determination device, a virtual machine placement determination method, and a virtual machine placement determination program, capable of determining a virtual machine placement that increases the availability of an application system configured by a virtual machine.

### BACKGROUND ART

In recent years, the construction examples of an application system using a virtual machine have increased. Whereas the flexibility and the efficiency of the system increase by using a virtual machine, the decrease in the availability and the reliability has been a concern. In a mission-critical application system, the availability equivalent to the conventional system is required even when a virtual machine is used. Here, the availability represents the probability that a system is available. For example, when the application system achieves the availability of 99.99%, the probability that the system cannot be used in one year is 0.01%, which corresponds to the down time of about 52 minutes (=60 minutes*24*365*0.0001) per year. Typically, the availability of a system is calculated by the following equation by using the mean time to failure (MTTF) of a system and the mean time to repair (MTTR) during failure.

Availability=MTTF/(MTTF+MTTR) (Formula 1)

The MTTF and the MTTR are determined by the fragility of a component constituting the application system, the ease of replacement, and the like. Therefore, it is important to understand the configuration of the application system so as to evaluate the availability.

When an application system is configured by using a virtual machine, the availability of the application system is largely dependent on the placement method of the virtual machine. The placement method of a virtual machine is a method of determining in which physical server each virtual machine constituting the application system is to be operated. For example, in an application system that takes a redundant configuration by using two virtual machines, there is a method of placement the two virtual machines in the same physical server and a method of placement them in a different physical server. The difference of the placement method affects the availability of the application system. Typically, so that the availability of an application system is maintained even when a plurality of virtual machines fail simultaneously by a single physical server failure, a method of distributed-placement the virtual machines in different physical servers is taken. In PTL 1, a method of achieving higher availability of an application system by imposing the limitation that redundant virtual servers are placed in different physical servers to determine the virtual server placement is described.

### CITATION LIST

### Patent Literature

PTL 1: JP 5035011 B2

### SUMMARY OF INVENTION

### Technical Problem

However, when there are three or more redundant virtual servers (virtual machines), or when the reliability of each of the physical servers is different, there is a possibility that high availability of an application system cannot be achieved only by simple placement rules such as those described in PTL 1. For example, when there are a very reliable physical server and an unreliable physical server, the method of distributed-placement virtual servers does not necessarily improve the availability of the application system. In addition, for example, in an application system including six redundant virtual machines, it is difficult to determine in which case the availability is higher between the cases of placement two virtual machines each in three physical servers and placement three virtual machines each in two physical servers. Furthermore, when elements constituting the application system are configured to depend on each other by having call relationships and complementary relationships (redundancy), it is difficult to determine which constituent elements should be combined and placed in physical servers so as to be able to maximize the availability.

That is, when an application system is configured by using virtual machines, there are the following problems.

The first problem is that by using a simple rule to distributed-placement the redundant virtual machines, the optimal placement cannot be determined from the viewpoint of availability of an application system configured by using virtual machines. The reason is that when there are three or more redundant virtual servers, or when the physical servers at the placement destinations have differences in reliability, the availability of the application system does not necessarily be maximized by the distributed placement.

The second problem is that it is difficult to determine the optimal virtual machine placement from the viewpoint of availability of the entire application system with regard to the application system configured by combinations of a plurality of components. The reason is that in a placement system where only the redundant configuration is considered, the reliability of each application component and the impact of the connection relationship between components on the reliability are not considered.

Therefore, the present invention has an object to provide a virtual machine placement determination device, a virtual machine placement determination method, and a virtual machine placement determination program, determining the virtual machine placement capable of further improving the availability of an application system configured by using virtual machines.

### Solution to Problem

A virtual machine placement determination device according to the present invention includes: a virtual machine placement proposal search unit configured to search for a virtual machine placement proposal satisfying resource limitation to enumerate; an availability model synthesizing unit configured to reflect a configuration of an application on each virtual machine placement proposal to generate an availability model for obtaining availability indicating a probability that the application is in an activation state; an application availability evaluation unit configured to analyze the availability model to calculate an availability evaluation value indicating the availability of an application system constructed by the virtual machine placement proposal; and a virtual machine placement ranking unit configured to rank each virtual machine placement proposal based on the availability evaluation value to determine a virtual machine placement proposal applied to the application.

A virtual machine placement determination method according to the present invention includes: searching for a virtual machine placement proposal satisfying a resource limitation to enumerate; reflecting a configuration of an application on each virtual machine placement proposal to generate an availability model for obtaining availability indicating a probability that the application is in an activation state; analyzing the availability model to calculate an availability evaluation value indicating the availability of an application system constructed by the virtual machine placement proposal; and ranking each virtual machine placement proposal based on the availability evaluation value to determine a virtual machine placement proposal applied to the application.

A virtual machine placement determination program according to the present invention causes computer to execute: a process of searching for a virtual machine placement proposal satisfying a resource limitation to enumerate; a process of reflecting a configuration of an application on each virtual machine placement proposal to generate an availability model for obtaining availability indicating a probability that the application is in an activation state; a process of analyzing the availability model to calculate an availability evaluation value indicating the availability of an application system constructed by the virtual machine placement proposal; and a process of ranking each virtual machine placement proposal based on the availability evaluation value to determine a virtual machine placement proposal applied to the application.

### Advantageous Effects of Invention

According to the present invention, it is possible to determine the virtual machine placement capable of further improving the availability of an application system configured by using virtual machines.

### BRIEF DESCRIPTION OF DRAWINGS

FIG. 1 It depicts a block diagram illustrating a configuration of a first exemplary embodiment of a virtual machine placement determination device according to the present invention.

FIG. 2 It depicts a block diagram illustrating the internal configuration of the availability model synthesizing unit in the first exemplary embodiment.

FIG. 3 It depicts a flow chart illustrating the operation in the first exemplary embodiment of the virtual machine placement determination device.

FIG. 4 It depicts an illustrative diagram showing an example of a prototype of the availability model in the first exemplary embodiment.

FIG. 5 It depicts an illustrative diagram showing an example of the configuration of an application system.

FIG. 6 It depicts an illustrative diagram showing an example of the information of the host machine being the virtual machine placement target.

FIG. 7 It depicts an illustrative diagram showing an example of virtual machine placement proposals.

FIG. 8 It depicts an illustrative diagram showing an example of the prototype of a reliability block diagram derived from the configuration of the Web application system.

FIG. 9 It depicts an illustrative diagram showing an example of availability models synthesized in response to the virtual machine placement proposals.

FIG. 10 It depicts an illustrative diagram showing an example of the parameter information for the availability evaluation.

FIG. 11 It depicts an illustrative diagram showing an example of an availability evaluation result with respect to each virtual machine placement proposal.

FIG. 12 It depicts a block diagram illustrating a configuration of a second exemplary embodiment of a virtual machine placement determination device according to the present invention.

FIG. 13 It depicts a flow chart illustrating the operation in the second exemplary embodiment of the virtual machine placement determination device.

FIG. 14 It depicts an illustrative diagram showing an example of a performance model by the queue network in the second exemplary embodiment.

FIG. 15 It depicts a block diagram illustrating a configuration of a third exemplary embodiment of the virtual machine placement determination device according to the present invention.

FIG. 16 It depicts a block diagram showing a summary of the virtual machine placement determination device according to the present invention.

### DESCRIPTION OF EMBODIMENTS

### First Exemplary Embodiment

In the following, the first exemplary embodiment of the present invention will be described with reference to the drawings.

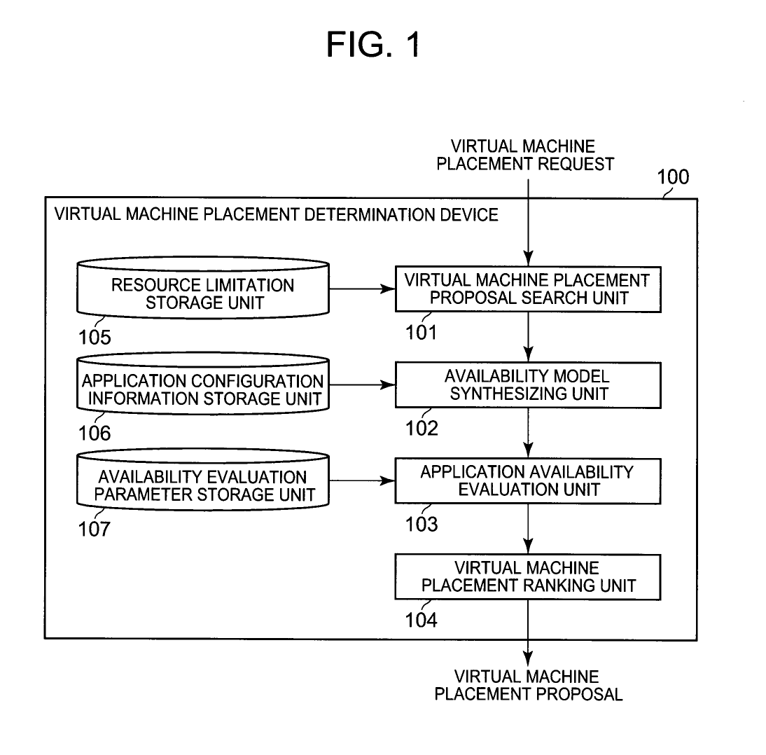

FIG. 1 is a block diagram illustrating a configuration of a first exemplary embodiment of a virtual machine placement determination device according to the present invention. As shown in FIG. 1, the virtual machine placement determination device in the first exemplary embodiment (virtual machine placement determination device 100) includes: a virtual machine placement proposal search unit 101, an availability model synthesizing unit 102, an application availability evaluation unit 103, a virtual machine placement ranking unit 104, a resource limitation storage unit 105, an application configuration information storage unit 106, and an availability evaluation parameter storage unit 107.

The virtual machine placement proposal search unit 101 receives the virtual machine placement request input by the input device of the computer, refers to the resource limitation stored in the resource limitation storage unit 105, and searches for the virtual machine placement proposals, that is, the candidates of the virtual machine placement, to enumerate.

The availability model synthesizing unit 102 synthesizes the availability model for a given virtual machine placement proposal by referring to the configuration information of the application system stored in the application configuration information storage unit 106 (hereinafter referred to as “application configuration information”). It should be noted that it can be said that to synthesize an availability model is to generate the availability model.

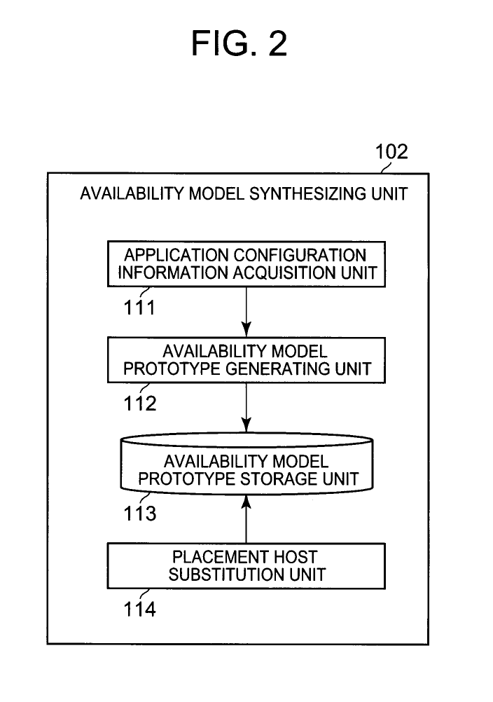

FIG. 2 is a block diagram illustrating the internal configuration of the availability model synthesizing unit 102 in the first exemplary embodiment. As shown in FIG. 2, the availability model synthesizing unit 102 includes an application configuration information acquisition unit 111, an availability model prototype generating unit 112, an availability model prototype storage unit 113, and a placement host substitution unit 114.

The application configuration information acquisition unit 111 acquires the application configuration information stored in the application configuration information storage unit 106.

The availability model prototype generating unit 112 creates a prototype of the availability model based only on the configuration of the application system (hereinafter referred to as an “availability model prototype”) to store in the availability model prototype storage unit 113.

The availability model prototype storage unit 113 stores the availability model prototype.

The placement host substitution unit 114 specifies a host machine corresponding to each virtual machine (hereinafter simply referred to as a “host”) from the virtual machine placement proposal and gives the host information to the prototype of the availability model. The host information is the information indicating the correspondence between the virtual machine and the host of placement target of the virtual machine.

The application availability evaluation unit 103 refers to the parameter information for the availability evaluation (hereinafter referred to as “availability evaluation parameter information”) stored in the availability evaluation parameter storage unit 107, and calculates the availability of the application system by evaluating the given availability model.

The virtual machine placement ranking unit 104 scores each virtual machine placement proposal based on the calculated value of the availability (hereinafter referred to as an “availability evaluation value”) to rank (ranking), and outputs a virtual machine placement proposal achieving the highest score.

The resource limitation storage unit 105 stores the resource limitation information. The resource limitation information includes, for example, the amount of resources required by the virtual machine, and the information indicating the amount of resources mounted by the physical server.

The application configuration information storage unit 106 stores the application configuration information.

The availability evaluation parameter storage unit 107 stores the availability evaluation parameter information.

According to such a configuration, the virtual machine placement determination device 100 synthesizes an availability model with respect to a virtual machine placement proposal to evaluate the availability, and selects the virtual machine placement proposal having the highest availability evaluation value. Thereby, the virtual machine placement determination device 100 can determine the virtual machine placement capable of improving the availability of the application system even when there are three or more redundant virtual machines, or when the hosts have differences in reliability.

It should be noted that the virtual machine placement proposal search unit 101, the availability model synthesizing unit 102 (the application configuration information acquisition unit 111, the availability model prototype generating unit 112, and the placement host substitution unit 114), the application availability evaluation unit 103, and the virtual machine placement ranking unit 104 are, for example, implemented by a computer operating in accordance with the virtual machine placement determination program. In this case, the CPU reads the virtual machine placement determination program, and operates, in accordance with the program, as the virtual machine placement proposal search unit 101, the availability model synthesizing unit 102 (the application configuration information acquisition unit 111, the availability model prototype generating unit 112, and the placement host substitution unit 114), the application availability evaluation unit 103, and the virtual machine placement ranking unit 104. In addition, the virtual machine placement proposal search unit 101, the availability model synthesizing unit 102 (the application configuration information acquisition unit 111, the availability model prototype generating unit 112, and the placement host substitution unit 114), the application availability evaluation unit 103, and the virtual machine placement ranking unit 104 may be implemented in separate hardware.

The resource limitation storage unit 105, the application configuration information storage unit 106, the availability evaluation parameter storage unit 107, and the availability model prototype storage unit 113 in the availability model synthesizing unit 102 are specifically implemented by storage devices such as an optical disk device, a magnetic disk device, and a memory included in the virtual machine placement determination device 100.

Next, the operation of the present exemplary embodiment will be described.

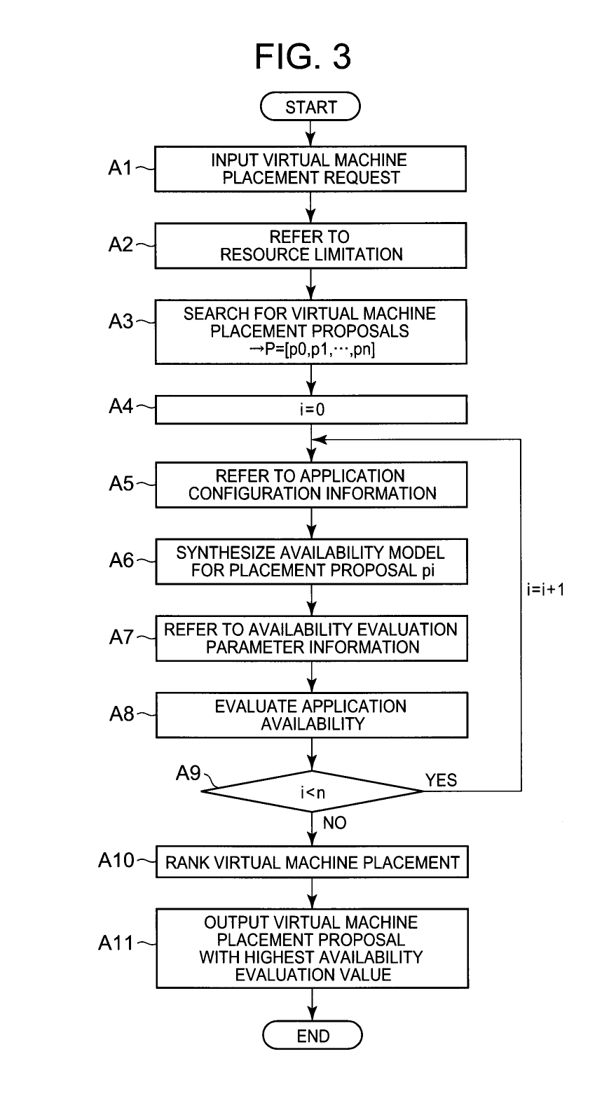

FIG. 3 is a flow chart illustrating the operation in the first exemplary embodiment of the virtual machine placement determination device.

First, the virtual machine placement proposal search unit 101 inputs the virtual machine placement request (step A1). In the present exemplary embodiment, as the virtual machine placement request, the user enters the list of virtual machines whose placement is requested to be determined and the list of hosts to be the placement targets. Here, the case where the host is a server device will be exemplified.

The virtual machine placement proposal search unit 101 refers to the resource limitation information stored in the resource limitation storage unit 105, and acquires the resource amount required by each virtual machine and the resource amount mounted on each host (step A2). It should be noted that these pieces of information may be part of the virtual machine placement requests. That is, in step A1, the virtual machine placement proposal search unit 101 may enter the virtual machine placement request including these pieces of information.

The virtual machine placement proposal search unit 101 searches for the virtual machine placement proposal so that the resources requested by each virtual machine are fully satisfied by the placement to the host server, based on the information of the acquired resources (step A3). Here, let the virtual machine placement proposal, obtained as a result of search, be P={p0, p1, . . . , pn}. The virtual machine placement proposal search unit 101 outputs the virtual machine placement proposal to the availability model synthesizing unit 102.

The availability model synthesizing unit 102 performs the processes of steps A5 to A8 on each virtual machine placement proposal pi (0≦i≦n) to synthesize the availability model (step A4).

First, the application configuration information acquisition unit 111 of the availability model synthesizing unit 102 acquires the application configuration information stored in the application configuration information storage unit 106 (step A5). The application configuration information includes, for example, the components of the application necessary to be operated as a virtual machine and the information indicating the connection relationship between the components.

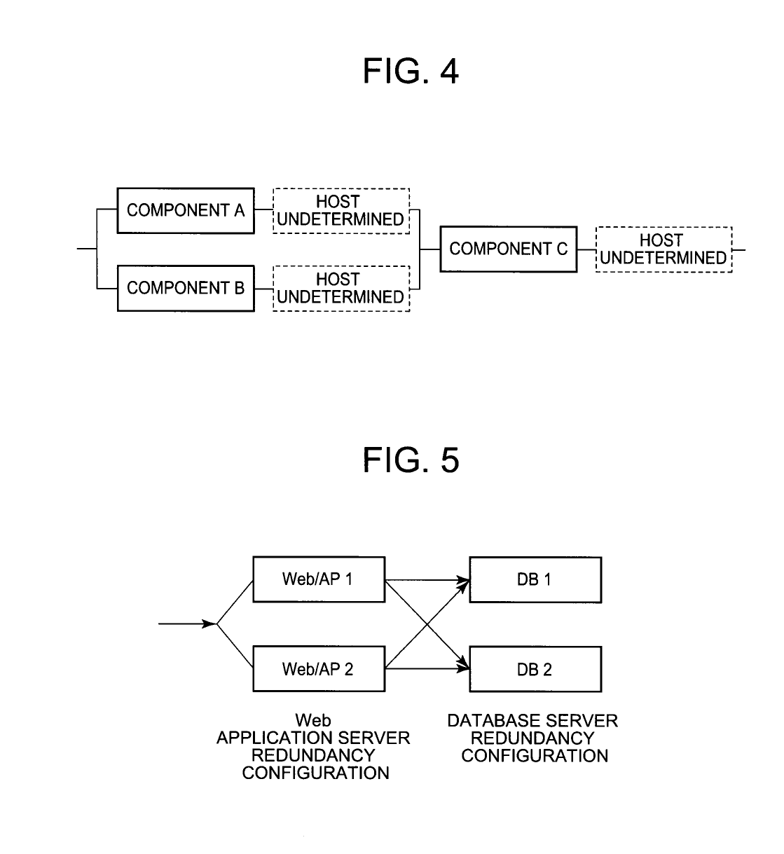

The connection relationships between components are, for example, the call relationship and the redundancy relationship. Based on the application configuration information, the availability model prototype generating unit 112 generates a prototype of the availability model to store in the availability model prototype storage unit 113. FIG. 4 is an illustrative diagram showing an example of a prototype of the availability model in the first exemplary embodiment.

In the example shown in FIG. 4, the application includes a component A, a component B, and a component C. Then, the component A and the component B are in the redundancy relationship, and the component C is in the call relationship with the pair of the component A and the component B. Each component needs to be placed in any one of the hosts as a virtual machine. However, it is undetermined in which host each component is to be placed. Thus, the availability model of the application where the assignment of a host is not determined is defined as a prototype. As shown in FIG. 4, in the present exemplary embodiment, the portion where the assignment of a host is not determined (hereinafter referred to as an “undetermined host block”), that is, the undetermined constituent element is represented by a dotted line.

The placement host substitution unit 114 synthesizes the availability model with respect to the virtual machine placement proposal pi (step A6). Specifically, the placement host substitution unit 114 specifies a host being the placement target of the virtual machine from each virtual machine placement proposal, and substitutes the host information into the undetermined host block in the availability model prototype.

Next, the application availability evaluation unit 103 acquires the availability evaluation parameter information from the availability evaluation parameter storage unit 107 (step A7). The availability evaluation parameter information includes at least the information indicating the MTTF and the MTTR of each component and each host. The application availability evaluation unit 103 evaluates the availability model for the virtual machine placement proposal pi with the availability evaluation parameter information as the input to calculate the availability evaluation value (step A8). In this case, the application availability evaluation unit 103 uses a general evaluation means for the availability model synthesized in step A6. For example, the model shown in FIG. 4 is configured as a reliability block diagram (RBD), and therefore the application availability evaluation unit 103 may use the calculation method for determining the availability of the entire system by a reliability block diagram (multiplication of probability) as the evaluation means.

The virtual machine placement determination device 100 performs the synthesis and the evaluation of the availability model in steps A5 to A8 for all of the virtual machine placement proposals (step A9). Then, the virtual machine placement ranking unit 104 ranks the virtual machine placement proposals based on each calculated availability evaluation value (step A10). The virtual machine placement ranking unit 104 outputs a virtual machine placement proposal having the highest availability evaluation value, based on the result of the ranking (step A11).

Next, the operation of the present exemplary embodiment will be described by using a specific example.

FIG. 5 is an illustrative diagram showing an example of the application configuration information, specifically, the configuration information of the Web application. Here, the case where the virtual machine placement determination device 100 builds a Web application system by placement each component (server) of the Web application shown in FIG. 5 in a plurality of hosts (physical servers) based on the virtual machine placement proposal will be exemplified.

The Web application (Web application system) includes two Web application servers (Web/AP 1 and Web/AP 2) and two database (DB) servers (DB 1 and DB 2). In addition, at least one Web application server and one DB server are required to operate so that the Web application system operates.

Here, a method of operating these servers as virtual machines to be placed in physical servers will be considered.

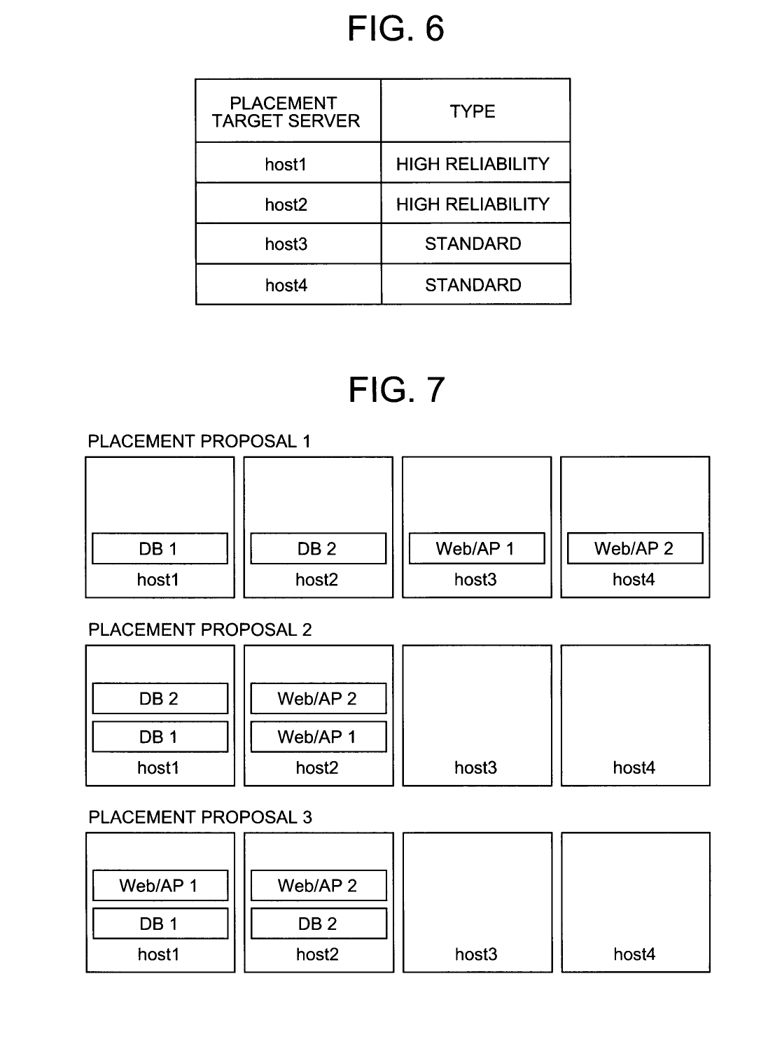

FIG. 6 is an illustrative diagram showing an example of a list of physical servers available as placement targets of the virtual machine. In FIG. 6, four physical servers (hosts 1 to 4) are illustrated. The hosts 1 and 2 are highly reliable servers and have high reliability as server devices. The hosts 3 and 4 are standard physical servers. These pieces of information are, for example, input into the virtual machine placement determination device 100, specifically, the virtual machine placement proposal search unit 101 of the virtual machine placement determination device 100 by the user and the like as part of the virtual machine placement requests.

When the virtual machine placement request is entered, the virtual machine placement proposal search unit 101 searches for the virtual machine placement proposal based on the list shown in FIG. 6 and the resource limitation information. Here, as the resource limitation, the limitation “the maximum number of the virtual machines that can be placed in the physical server is up to two.” is assumed to be given. FIG. 7 is an illustrative diagram showing an example of the virtual machine placement proposals obtained as a result of the search based on the limitation. For example, the placement proposal 1 shown in FIG. 7 represents the proposal where the DB 1 is placed in the host 1, the DB 2 is placed in the host 2, the Web/AP 1 is placed in the host 3, and the Web/AP 2 is placed in the host 4.

Next, the virtual machine placement determination device 100 synthesizes the availability model with respect to the obtained virtual machine placement proposal.

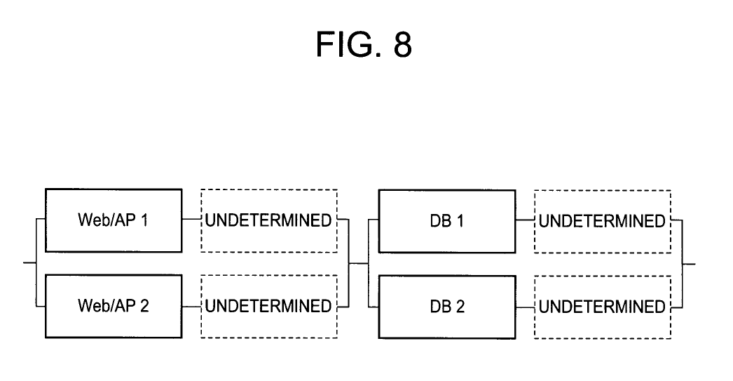

First, the availability model synthesizing unit 102 creates a prototype of the availability model based on the application configuration information. The availability model synthesizing unit 102 expresses, for example, the configuration of the Web application system shown in FIG. 5 as a prototype of the reliability block diagram as shown in FIG. 8. FIG. 8 is an illustrative diagram showing an example of the prototype of the reliability block diagram derived from the configuration of the Web application system. In the reliability block diagram shown in FIG. 8, the Web/AP server clusters and the DB clusters are in the call structure, and each cluster includes two virtual servers. Each virtual server operates in any one of the physical servers (hosts). However, it is undetermined in which host each virtual server is to be operated.

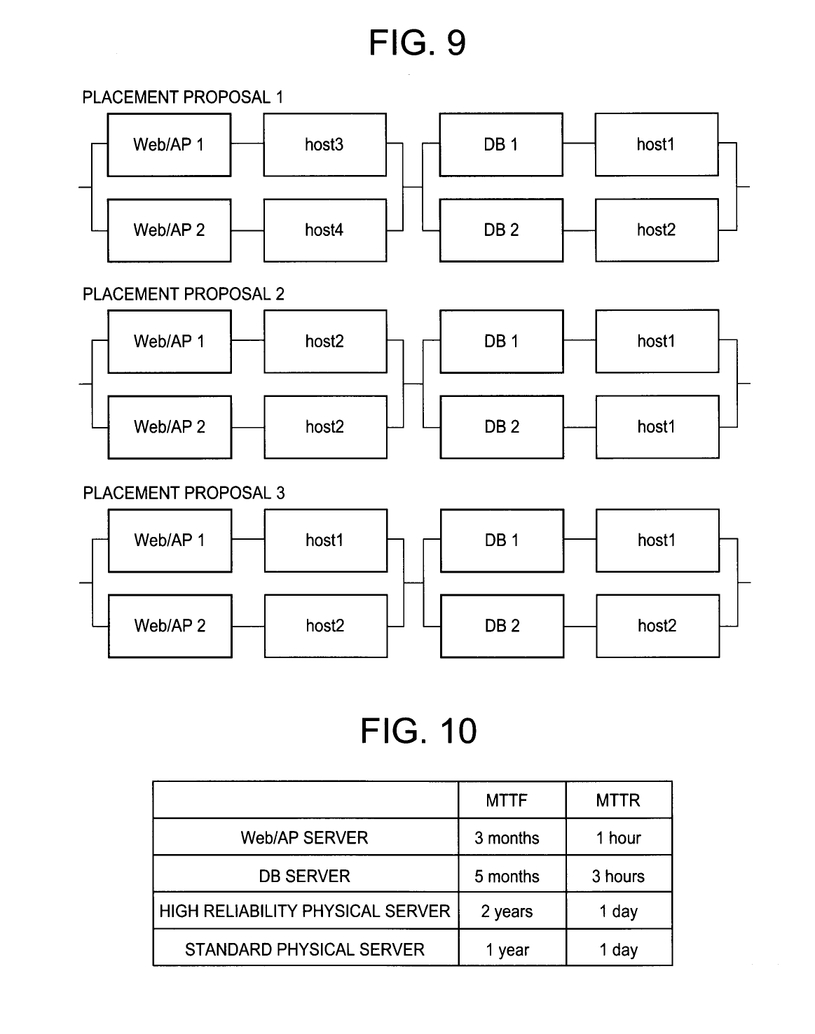

The placement host substitution unit 114 of the availability model synthesizing unit 102 synthesizes the availability model based on the virtual machine placement proposal. Specifically, the placement host substitution unit 114 determines the virtual server to be placed in an undetermined host (a host where it is undetermined which virtual server is to be operated) for each virtual machine placement proposal. The reliability block diagram obtained by corresponding to each virtual machine placement proposal shown in FIG. 7 (the synthesized availability model) is shown in FIG. 9. FIG. 9 is an illustrative diagram showing an example of availability models synthesized in response to the virtual machine placement proposals.

In the reliability block diagram for the placement proposal 2, two blocks of the host 2 appear as shown in FIG. 9. The two blocks correspond to the same system constituent element, that is, the host 2, and referred to as “mirror blocks”. The mirror blocks are necessary to be treated as one constituent element at the time of the availability calculation. That is, the application availability evaluation unit 103 calculates the availability of the Web application system in view of the fact that two blocks are simultaneously lost when the host 2 fails.

When the availability model is synthesized for the virtual machine placement proposal, the application availability evaluation unit 103 performs the availability evaluation. In this case, the availability evaluation parameter information stored in the availability evaluation parameter storage unit 107 is required. FIG. 10 is an illustrative diagram showing an example of the availability evaluation parameter information. The availability evaluation parameter information shown in FIG. 10 represents mean time to failure (MTTF) and mean time to repair (MTTR) corresponding to each constituent element.

The application availability evaluation unit 103 calculates the availability of each component (Web/AP 1, Web/AP 2, DB 1, and DB 2) from Eq. (1) based on the value of the MTTF and the MTTR. The application availability evaluation unit 103 gives the value indicating the calculated availability of each component (availability evaluation value) to the availability model, and calculates the availability of the entire Web application system by analyzing the availability model. When the availability model is a reliability block diagram, the application availability evaluation unit 103 may calculate the availability of the entire Web application system in accordance with the standard means configured to analyze the reliability block diagram. For example, when the availability A_sys of the entire Web application system is to be obtained from the reliability block diagram for the placement proposal 1 shown in FIG. 9, A_sys is calculated by the following equation.

A_{—}sys={1−(1−A_{—}w1*A_{—}h3)*(1−A_{—}w2*A_{—}h4)}*{1−(1−A_{—}d1*A_{—}h1)*(1−A_{—}d2*A_{—}h2)}

Provided that A_w1, A_w2, A_d1, A_d2, A_h1, A_h2, A_h3, and A_h4 represent the availability of Web/AP 1, Web/AP 2, DB 1, DB 2, host 1, host 2, host 3, and host 4, respectively.

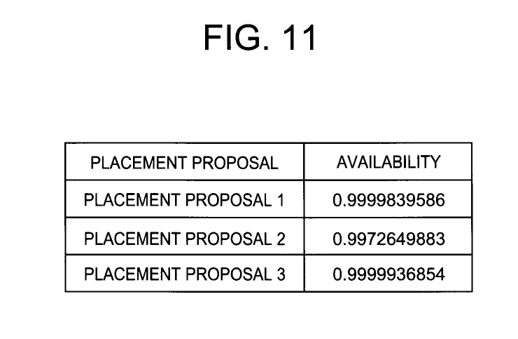

By the availability model being evaluated in this manner, the availability of the application system different for each virtual machine placement proposal can be obtained quantitatively. FIG. 11 is an illustrative diagram showing an example of the availability evaluation result corresponding to each placement proposal shown in FIG. 7. From the results shown in FIG. 11, the placement proposal 3 is ascertained to maximize the availability of the application system among the three placement proposals. When the conventional distributed-placement method, that is, the method of distributed-placement virtual machines in different physical servers is used, the placement proposal 1 is to be selected, and therefore the best placement proposal from the viewpoint of availability cannot be selected. In contrast to this, in the present exemplary embodiment, the virtual machine placement ranking unit 104 ranks the virtual machine placement proposals based on the availability evaluation results, and therefore the virtual machine placement proposal achieving ultimately the highest availability can be selected.

As described above, in the present exemplary embodiment, the virtual machine placement proposal search unit searches for the virtual machine placement proposals satisfying the limitation of resources for the virtual machine placement request to enumerate. Then, the availability model synthesizing unit synthesizes the availability model for each virtual machine placement proposal, and the application availability evaluation unit evaluates the synthesized availability model. Then, the virtual machine placement ranking unit outputs the virtual machine placement proposal having the highest availability evaluation value. According to such a configuration, the virtual machine placement proposal capable of improving the availability of the application system can be determined and be output. That is, the placement proposal not optimal from the viewpoint of availability can be avoided to be output.

In contrast, in the system of determining the virtual machine placement according to the distributed-placement method as described in PTL 1, the placement proposal not optimal from the viewpoint of availability may be output.

It should be noted that in the present exemplary embodiment, the case where the availability model prototype generating unit 112 constitutes the prototype of the reliability block diagram, that is, the case where the availability of the system (application system) is calculated by the operating components being focused on is described. On the other hand, the availability model prototype generating unit 112 may configure the prototype of the fault tree by setting undetermined host failure events representing the failure events of the host where it is undetermined that which virtual machine is to be operated as an input element.

The fault tree is one of the methods of reliability model where the combination of failure events that the entire system leads to failure is described by using the logic gates such as AND (logical product) and OR (logical sum) by setting the failure event of the components constituting the system as an input. By assigning the probability that failure occurs to each failure event, the probability that the entire system fails can be calculated in accordance with the logical expression defined by the fault tree. Given that the probability to be assigned to each failure event, that is, the probability given to the input of the fault tree is set to the non-availability of each component (=1−“availability of a component”), the non-availability of the entire system can be calculated by the fault tree. In this case, the availability of the system is calculated as 1−“non-availability of the entire system”. According to such a configuration, it is possible to quantitatively calculate the availability of the system by focusing on failure events.

In addition, the availability model prototype generating unit 112 may constitute the prototype of the failure/recovery state transition model of the system by setting the state transition model representing the failure/recovery state transition of the host where it is undetermined that which virtual machine is to be operated (hereinafter referred to as a “failure/recovery state transition model”) as an input element.

Here, in the availability analysis, the state transition model is a model for describing the state transition of the system by the probability process, and for obtaining the availability index by the analysis of the probability process. As the most basic probability process, there is a continuous-time Markov chain. In addition, as the application, there is a model and the like using the Petri net. When the availability is calculated in the state transition model, the state where the system operates in the state transition model is defined first. Next, by the steady-state analysis of the state transition model (probability process), the probability that the system is in the activation state after a long period of time elapses is calculated. The probability calculated in this case represents the availability of the system. According to such a configuration, when the availability of the system is to be obtained, the complex dependencies in the system where the modeling is difficult by using the combination model of reliability block diagrams, fault tree, and the like (for example, the time for detecting the failure and the sequence of recovery processes) can be considered.

### Second Exemplary Embodiment

In the following, the second exemplary embodiment of the present invention will be described with reference to the drawings.

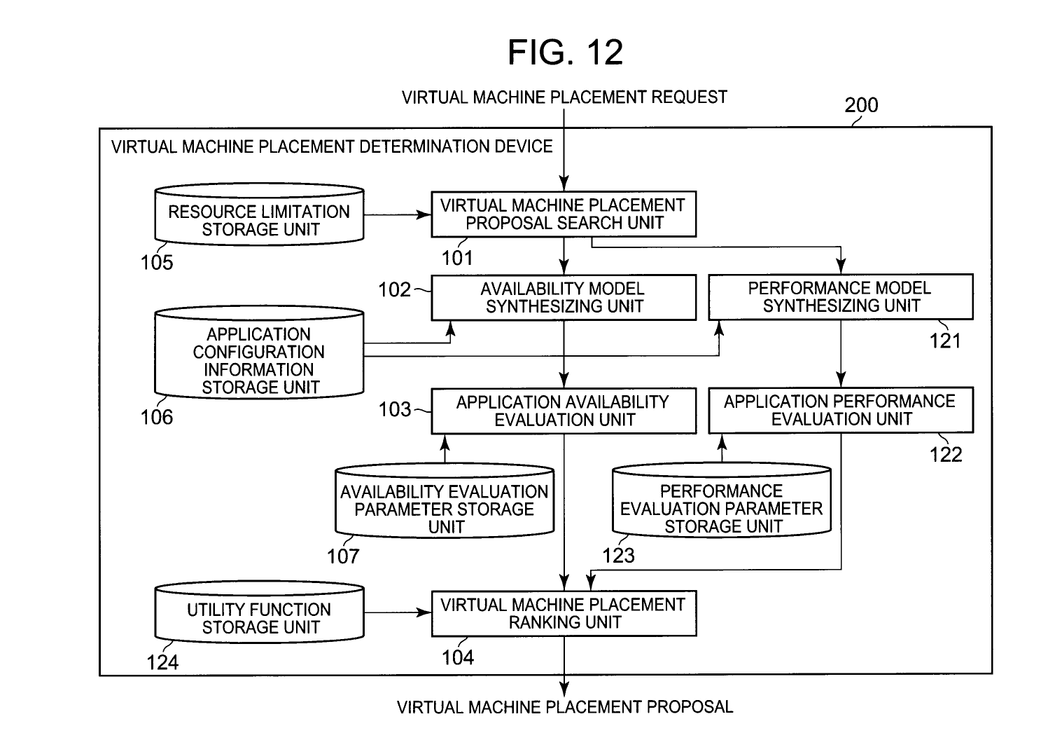

FIG. 12 is a block diagram illustrating a configuration of a second exemplary embodiment of a virtual machine placement determination device according to the present invention.

As shown in FIG. 12, the virtual machine placement determination device in the second exemplary embodiment (virtual machine placement determination device 200) includes, in addition to the configuration of the first exemplary embodiment, a performance model synthesizing unit 121, an application performance evaluation unit 122, a performance evaluation parameter storage unit 123, and a utility function storage unit 124.

The performance model synthesizing unit 121 synthesizes a performance model for a given virtual machine placement proposal by referring to the application configuration information stored in the application configuration information storage unit 106.

The application performance evaluation unit 122 calculates the performance characteristics evaluation value indicating the performance characteristics of the application system by referring to the parameter information for the performance evaluation stored in the performance evaluation parameter storage unit 123 (hereinafter referred to as “performance evaluation parameter information”), and by evaluating the performance model for the given virtual machine placement proposal.

The performance evaluation parameter storage unit 123 stores the performance evaluation parameter information.

The utility function storage unit 124 stores the utility function.

The virtual machine placement ranking unit 104 refers to the utility function stored in the utility function storage unit 124, calculates the utility value from the availability evaluation value and the performance characteristics evaluation value for each virtual machine placement proposal, and outputs a virtual machine placement proposal achieving the highest utility value.

According to such a configuration, the virtual machine placement determination device 200 can evaluate both sides of the availability and the performance characteristics for the virtual machine placement proposal, and can determine the virtual machine placement proposal having the highest utility value by using the utility function. Thereby, the virtual machine placement determination device 200 can determine the virtual machine placement proposal having high availability and excellent performance characteristics.

It should be noted that the performance model synthesizing unit 121 and the application performance evaluation unit 122 are, for example, implemented by a computer configured to operate in accordance with the virtual machine placement determination program. In this case, the CPU reads the virtual machine placement determination program, and operates as the performance model synthesizing unit 121 and the application performance evaluation unit 122 in accordance with the program. In addition, the performance model synthesizing unit 121 and the application performance evaluation unit 122 may be implemented by separate hardware.

The performance evaluation parameter storage unit 123 and the utility function storage unit 124 are specifically implemented by the storage device such as the optical disk device, the magnetic disk device, and the memory included in the virtual machine placement determination device 200.

Next, the operation of the present exemplary embodiment will be described.

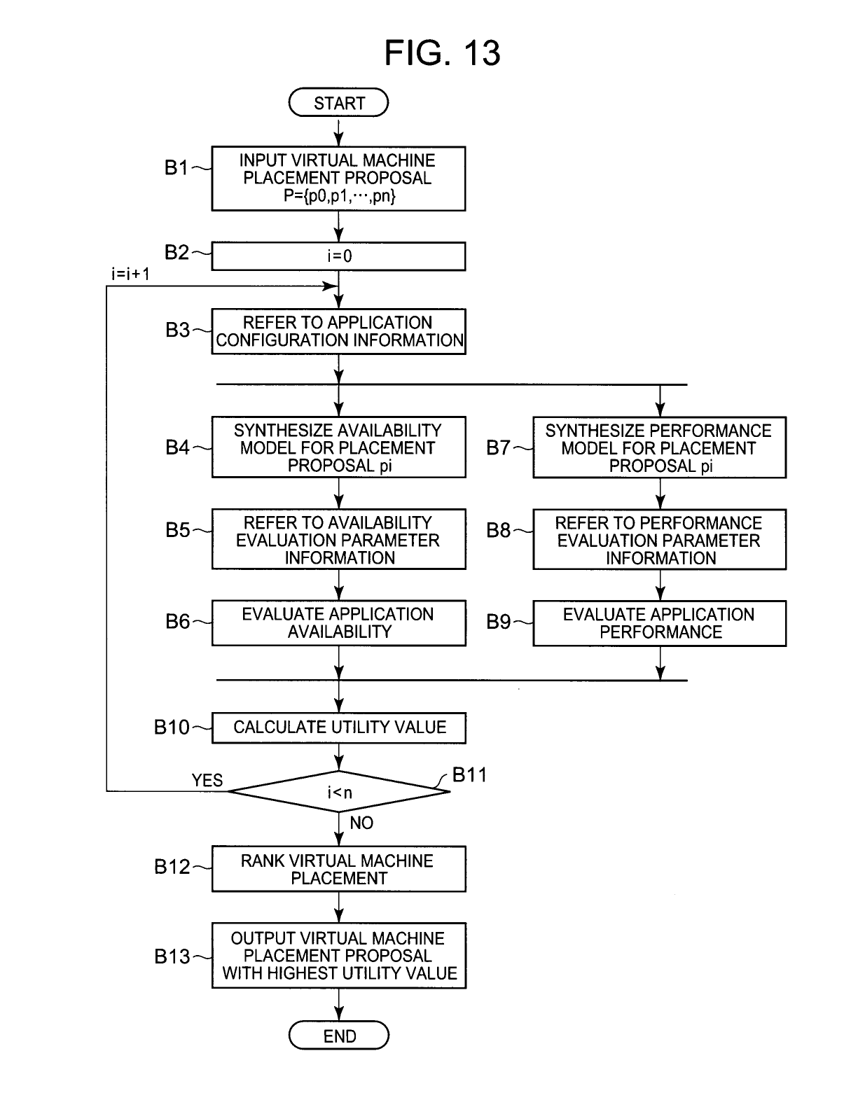

FIG. 13 is a flow chart illustrating the operation in the second exemplary embodiment of the virtual machine placement determination device.

First, the virtual machine placement proposal search unit 101 executes the processes in steps A1 to A3 shown in FIG. 3 in the same manner as the first exemplary embodiment, and searches for the virtual machine placement proposals. Here, let the virtual machine placement proposal, obtained as a result of search, be P={p0, p1, . . . , pn}.

The availability model synthesizing unit 102 and the performance model synthesizing unit 121 each enter the virtual machine placement proposals from the virtual machine placement proposal search unit 101 (step B1).

The availability model synthesizing unit 102 and the performance model synthesizing unit 121 execute the utility value calculation processing (processes in steps B3 to B10) shown below for each input virtual machine placement proposal pi (0≦i≦n) (step B2).

First, the availability model synthesizing unit 102 and the performance model synthesizing unit 121 acquire the application configuration information stored in the application configuration information storage unit 106 (step B3).

After step B3, the availability model synthesizing unit 102 synthesizes the availability model for the virtual machine placement proposal pi (step B4). Next, the application availability evaluation unit 103 refers to the availability evaluation parameter information stored in the availability evaluation parameter storage unit 107 (step B5), and evaluates the availability by using the evaluation method suited to the form of the availability model (step B6).

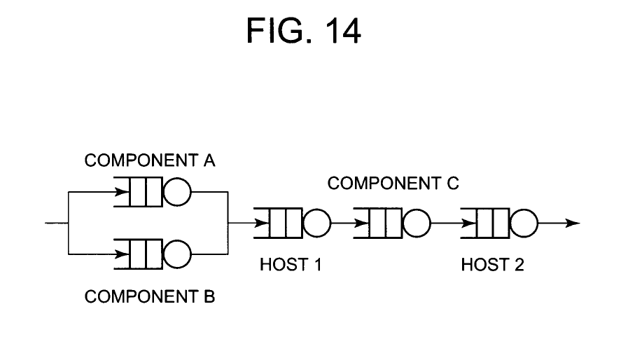

After step B3, the performance model synthesizing unit 121 synthesizes the performance model for the virtual machine placement proposal pi (step B7). For example, the performance model can be modeled as a queue network as shown in FIG. 14. In the queue network, each component and host are represented by a queue, and the network is modeled based on the placement configuration of the virtual machine and the call structure of the application. The queue network can be analyzed by methods such as simulation, and can estimate the performance characteristics such as the response time and the throughput of the application.

Next, the application performance evaluation unit 122 refers to the performance evaluation parameter information (step B8), and evaluates the performance characteristics by using the evaluation method suited to the form of the performance model (step B9). The queue network as shown in FIG. 14 can be, for example, evaluated by simulation. At that time, the application performance evaluation unit 122 requires the service period of the virtual machine and the host configured to operate each component, the arrival rate of the requests assumed by the performance evaluation, and the like as the parameter information. These pieces of parameter information are stored in advance in the performance evaluation parameter storage unit 123 as the performance evaluation parameter information.

When the availability model synthesizing unit 102 and the performance model synthesizing unit 121 finish the availability evaluation and the performance evaluation, the virtual machine placement ranking unit 104 refers to the utility function stored in the utility function storage unit 124, and calculates the utility value of the virtual machine placement proposal based on the utility function (step B10). The utility function is given as a function of the availability evaluation value by the availability evaluation and the performance characteristics evaluation value by the performance evaluation (e.g. response time). The virtual machine placement ranking unit 104 can utilize, for example, the utility function F as follows. Provided that c0 and c1 are coefficients, and are determined in advance by the user depending on the use of the application.

F=c0*[availability evaluation value]+c1*[performance characteristic evaluation value (response time)]

The virtual machine placement determination device 200 executes the processes in steps B3 to B10 for all of the virtual machine placement proposals pi (step B11).

Lastly, the virtual machine placement ranking unit 104 ranks the virtual machine placement proposals based on the calculated utility values (step B12). The virtual machine placement ranking unit 104 outputs a virtual machine placement proposal having the highest utility value based on the results of the ranking (step B13).

As described above, in the present exemplary embodiment, the virtual machine placement determination device performs the evaluation of the performance characteristics by using the performance model, simultaneously with the evaluation by using the availability model for each virtual machine placement proposal. In addition, the virtual machine placement determination device calculates the utility value from the availability evaluation value and the performance characteristics evaluation value by using the utility function, and outputs a virtual machine placement proposal having the highest utility value. Therefore, in view of both the availability and the performance characteristics, the virtual machine placement proposals can be ranked. Therefore, the virtual machine placement proposal excellent in both the availability and the performance characteristics can be determined.

### Third Exemplary Embodiment

In the following, the third exemplary embodiment of the present invention will be described with reference to the drawings.

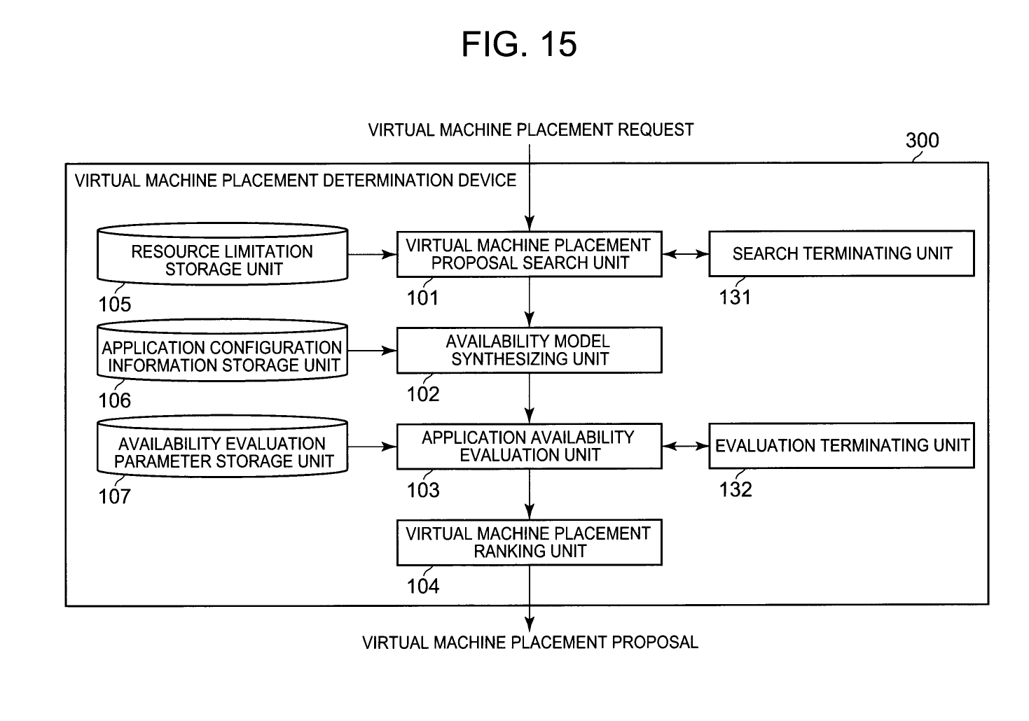

FIG. 15 is a block diagram illustrating a configuration of a third exemplary embodiment of a virtual machine placement determination device according to the present invention.

The virtual machine placement determination device in the third exemplary embodiment (virtual machine placement determination device 300) includes a search terminating unit 131 and an evaluation terminating unit 132 in addition to the configuration of the first exemplary embodiment.

The search terminating unit 131 terminates the search processing of the virtual machine placement proposal in the virtual machine placement proposal search unit 101 according to the specified condition in advance, and inputs the virtual machine placement proposal obtained at that time into the availability model synthesizing unit 102.

The evaluation terminating unit 132 terminates the evaluation processing in the application availability evaluation unit 103 according to the specified condition in advance to acquire the evaluation result obtained at that time.

According to such a configuration, the virtual machine placement determination device 300 terminates the search processing and the evaluation processing according to the specified condition in advance, and selects the virtual machine placement proposal by using the results obtained at the time of termination. Thereby, the virtual machine placement determination device 300 can determine the virtual machine placement proposal having high availability in a short period of time even in the case of time-consuming search processing and evaluation processing.

Next, the operation of the present exemplary embodiment will be described.

The operation of the virtual machine placement determination device 300 is the same as the operation in the first exemplary embodiment shown in FIG. 3. However, the processes in steps A3 and A8 are different from the first exemplary embodiment. In the following, differences from the first exemplary embodiment will be described.

In step A3, when the virtual machine placement proposal search unit 101 searches for the candidates of the virtual machine placement meeting the resource limitation, there is a case where the number of the placement proposals becomes very large and a case where searching for all of the placement proposals is very time-consuming, depending on the scale of a given virtual machine placement request.

In such cases, the search terminating unit 131 terminates the search processing in the virtual machine placement proposal search unit 101 based on the condition set in advance for terminating the search. For example, the search terminating unit 131 may terminate the search processing based on the condition that the number of placement proposal for which the virtual machine placement proposal search unit 101 searches is limited to a certain number (e.g. 1000). That is, the search terminating unit 131 may terminate the search processing when the number of the placement proposals exceeds a certain number.

In addition, for example, the search terminating unit 131 may terminate the search processing based on the condition that the search time is limited to a certain period of time (e.g. five minutes). That is, when the search time exceeds the certain period of time, the search terminating unit 131 may terminate the search processing.

When the search is terminated by the search terminating unit 131, the virtual machine placement proposal search unit 101 outputs all of the placement proposals P={p0, p1, . . . , pn} obtained at the time as the candidates for the virtual machine placement.

In addition, in step A8, when the application availability evaluation unit 103 performs the availability evaluation, there is a case where the evaluation is very time-consuming depending on the scale of the availability model.

In such a case, the evaluation terminating unit 132 terminates the evaluation processing in the application availability evaluation unit 103 based on the condition set in advance for terminating the evaluation. For example, the evaluation terminating unit 132 may terminate the evaluation processing based on the condition of limiting the evaluation time to a certain period of time. That is, when the evaluation time exceeds the certain period of time, the evaluation terminating unit 132 may terminate the evaluation processing.

When the evaluation is terminated by the evaluation terminating unit 132, if there is an evaluation value obtained at the time, the application availability evaluation unit 103 outputs the evaluation value (intermediate result). If there is not such an intermediate result, the application availability evaluation unit 103 removes the placement proposal (virtual machine placement proposal pi), the evaluation of which is terminated, from the candidates for the virtual machine placement.

In the same manner as the first exemplary embodiment, after performing the availability evaluation (steps A5 to A8) on all of the virtual machine placement proposals, the virtual machine placement determination device 300 ranks the virtual machine placement proposals based on the availability evaluation results, and outputs the virtual machine placement proposal achieving the highest availability as a result of the ranking.

As described above, in the present exemplary embodiment, the search terminating unit terminates the search processing of the virtual machine placement proposal based on the given condition. In addition, the evaluation terminating unit terminates the evaluation processing of the availability model based on the given condition. Then, the virtual machine placement ranking unit selects the virtual machine placement proposal having high availability based on the results obtained when each processing is terminated. Therefore, even when there are very many candidates for the virtual machine placement and when the availability evaluation is time-consuming, the virtual machine placement proposal that improves the availability the most in the computable range can be determined.

It should be noted that the present invention can be applied to the application such as the operation management software of a data center that uses the server virtualization. In addition, the present invention can also be applied to the application such as the design support tool configured to design the configuration of a system that uses the server virtualization.

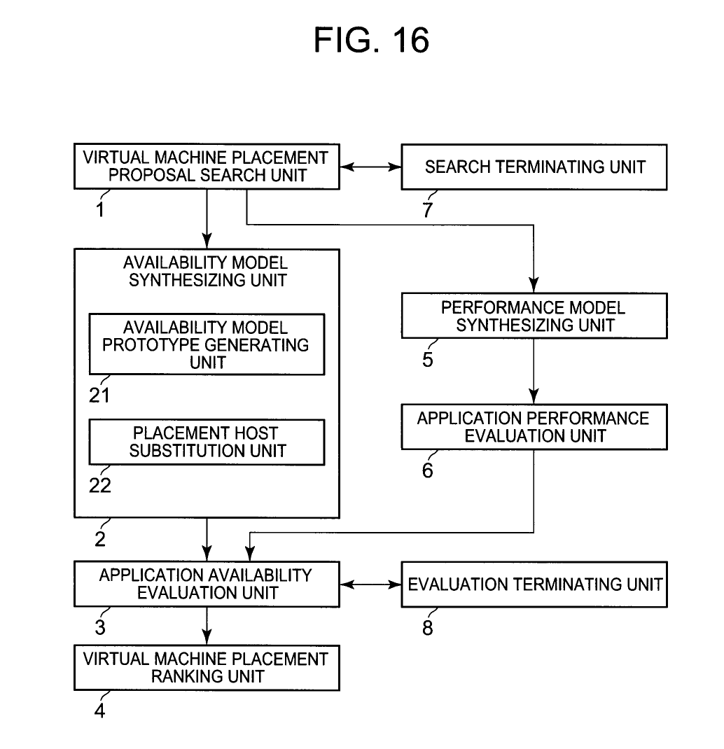

Next, the summary of the present invention will be described. FIG. 16 is a block diagram showing a summary of the virtual machine placement determination device according to the present invention. The virtual machine placement determination device according to the present invention includes:
a virtual machine placement proposal search unit 1 configured to search for a virtual machine placement proposal satisfying resource limitation to enumerate (corresponding to the virtual machine placement proposal search unit 101 shown in FIG. 1);
an availability model synthesizing unit 2 configured to reflect a configuration of an application on each virtual machine placement proposal to generate an availability model for obtaining availability indicating a probability that the application is in an activation state (corresponding to the availability model synthesizing unit 102 shown in FIG. 1);
an application availability evaluation unit 3 configured to analyze the availability model to calculate an availability evaluation value indicating the availability of an application system constructed by the virtual machine placement proposal (corresponding to the application availability evaluation unit 103 shown in FIG. 1); and
a virtual machine placement ranking unit 4 configured to rank each virtual machine placement proposal based on the availability evaluation value to determine the virtual machine placement proposal applied to the application (corresponding to the virtual machine placement ranking unit 104 shown in FIG. 1).

According to such a configuration, the virtual machine placement proposal capable of improving the availability of the application system can be determined. That is, the placement proposal not optimal from the viewpoint of availability can be avoided to be output.

In addition, the availability model synthesizing unit 2 may include:
an availability model prototype generating unit 21 configured to generate a prototype of the availability model including an undetermined constituent element based on configuration information of the application (corresponding to the availability model prototype generating unit 112 in the availability model synthesizing unit 102 shown in FIG. 2), and
a placement host substitution unit 22 configured to specify a host for placement a virtual machine based on the virtual machine placement proposal to substitute information relating to the host into the prototype of the availability model (corresponding to the placement host substitution unit 114 in the availability model synthesizing unit 2 shown in FIG. 2). According to such a configuration, the availability of the application system different for each virtual machine placement proposal can be determined quantitatively.

In addition, the availability model prototype generating unit 21 may generate a prototype of a reliability block diagram by using an undetermined host block representing a host where it is undetermined that which virtual machine is to be operated. According to such a configuration, the availability model can be evaluated by using a general evaluation means, for example, the multiplication of probabilities.

In addition, the availability model prototype generating unit 21 may generate a prototype of a fault tree by using an undetermined host failure event representing a failure event of a host where it is undetermined that which virtual machine is to be operated. According to such a configuration, it is possible to quantitatively calculate the availability of the system by focusing on failure events.

In addition, the availability model prototype generating unit 21 may generate a prototype of a failure/recovery state transition model of the application system by using a failure/recovery state transition model of a host where it is undetermined that which virtual machine is to be operated. According to such a configuration, when the availability of the system is to be obtained, the complex dependencies in the system where the modeling is difficult by using the combination model of reliability block diagrams, fault tree, and the like (for example, the time for detecting the failure and the sequence of recovery processes) can be considered.

In addition, the virtual machine placement determination device may include: a performance model synthesizing unit 5 configured to reflect a configuration of an application on each virtual machine placement proposal to generate a performance model for evaluating performance characteristics of the application (corresponding to the performance model synthesizing unit 121 in the virtual machine placement determination device 200 shown in FIG. 12); and an application performance evaluation unit 6 configured to analyze the performance model to calculate a performance characteristics evaluation value indicating performance characteristics of the application system constructed by each virtual machine placement proposal (corresponding to the application performance evaluation unit 122 in the virtual machine placement determination device 200 shown in FIG. 12), wherein the virtual machine placement ranking unit 4 may calculate a utility value from the availability evaluation value and the performance characteristics evaluation value by using a utility function, may rank the virtual machine placement proposal based on the utility value, and may determine the virtual machine placement proposal to be applied to the application. According to such a configuration, in view of both the availability and the performance characteristics, the virtual machine placement proposals can be ranked. Therefore, the virtual machine placement proposal excellent in both the availability and the performance characteristics can be determined.

In addition, the virtual machine placement determination device may include a search terminating unit 7 configured to terminate search processing in the virtual machine placement proposal search unit 1 based on a certain condition (corresponding to the search terminating unit 131 in the virtual machine placement determination device 300 shown in FIG. 15), wherein the application availability evaluation unit 3 may perform the availability evaluation on the virtual machine placement proposal obtained when the search processing is terminated as a target. According to such a configuration, when there are very many candidates for the virtual machine placement, the virtual machine placement proposal that improves the availability the most in the computable range can be determined.

In addition, the virtual machine placement determination device may include an evaluation terminating unit 8 configured to terminate evaluation processing in the application availability evaluation unit 3 based on a certain condition (corresponding to the evaluation terminating unit 132 in the virtual machine placement determination device 300 shown in FIG. 15), wherein the virtual machine placement ranking unit 4 ranks a virtual machine placement proposal based on an evaluation result obtained when the evaluation processing is terminated. According to such a configuration, when the availability evaluation is time-consuming, the virtual machine placement proposal that improves the availability the most in the computable range can be determined.

In addition, some or all of the above exemplary embodiments may also be described as the following supplementary notes, however, are not limited to them.

### (Supplementary Note 1)

A virtual machine placement determination device including: a virtual machine placement proposal search unit configured to search for a virtual machine placement proposal satisfying resource limitation to enumerate; an availability model synthesizing unit configured to reflect a configuration of an application on each virtual machine placement proposal to generate an availability model for obtaining availability indicating a probability that the application is in an activation state; an application availability evaluation unit configured to analyze the availability model to calculate an availability evaluation value indicating the availability of an application system constructed by the virtual machine placement proposal; and a virtual machine placement ranking unit configured to rank each virtual machine placement proposal based on the availability evaluation value to determine the virtual machine placement proposal applied to the application.

### (Supplementary Note 2)

The virtual machine placement determination device according to supplementary note 1, wherein the availability model synthesizing unit includes: an availability model prototype generating unit configured to generate a prototype of the availability model including an undetermined constituent element based on configuration information of the application; and a placement host substitution unit configured to specify a host for placement a virtual machine based on the virtual machine placement proposal to substitute information relating to the host into the prototype of the availability model.

### (Supplementary Note 3)

The virtual machine placement determination device according to supplementary note 2, wherein the availability model prototype generating unit generates a prototype of a reliability block diagram by using an undetermined host block representing a host where it is undetermined that which virtual machine is to be operated.

### (Supplementary Note 4)

The virtual machine placement determination device according to supplementary note 2, wherein the availability model prototype generating unit generates a prototype of a fault tree by using an undetermined host failure event representing a failure event of a host where it is undetermined that which virtual machine is to be operated.

### (Supplementary Note 5)

The virtual machine placement determination device according to supplementary note 2, wherein the availability model prototype generating unit generates a prototype of a failure/recovery state transition model of the application system by using a failure/recovery state transition model of a host where it is undetermined that which virtual machine is to be operated.

### (Supplementary Note 6)

The virtual machine placement determination device according to any one of supplementary notes 1 to 5, further including: a performance model synthesizing unit configured to reflect a configuration of an application on each virtual machine placement proposal to generate a performance model for evaluating performance characteristics of the application; and an application performance evaluation unit configured to analyze the performance model to calculate a performance characteristics evaluation value indicating performance characteristics of the application system constructed by each virtual machine placement proposal, wherein the virtual machine placement ranking unit calculates a utility value from the availability evaluation value and the performance characteristics evaluation value by using a utility function, ranks the virtual machine placement proposal based on the utility value, and determines the virtual machine placement proposal to be applied to the application.

### (Supplementary Note 7)

The virtual machine placement determination device according to any one of supplementary notes 1 to 6, further including a search terminating unit configured to terminate search processing in the virtual machine placement proposal search unit based on a certain condition, wherein the application availability evaluation unit performs the availability evaluation on the virtual machine placement proposal obtained when the search processing is terminated as a target.

### (Supplementary Note 8)

The virtual machine placement determination device according to any one of supplementary notes 1 to 7, further including an evaluation terminating unit configured to terminate evaluation processing in the application availability evaluation unit based on a certain condition, wherein the virtual machine placement ranking unit ranks a virtual machine placement proposal based on an evaluation result obtained when the evaluation processing is terminated.

### (Supplementary Note 9)

A virtual machine placement determination method including: searching for a virtual machine placement proposal satisfying a resource limitation to enumerate; reflecting a configuration of an application on each virtual machine placement proposal to generate an availability model for obtaining availability indicating a probability that the application is in an activation state; analyzing the availability model to calculate an availability evaluation value indicating the availability of an application system constructed by the virtual machine placement proposal; and ranking each virtual machine placement proposal based on the availability evaluation value to determine a virtual machine placement proposal applied to the application.

### (Supplementary Note 10)

The virtual machine placement determination method according to supplementary note 9, further including: generating a prototype of the availability model including an undetermined constituent element based on configuration information of the application; specifying a host placement a virtual machine based on the virtual machine placement proposal; and substituting information relating to the host into a prototype of the availability model.

### (Supplementary Note 11)

The virtual machine placement determination method according to supplementary note 10, further including generating a prototype of a reliability block diagram by using an undetermined host block representing a host where it is undetermined that which virtual machine is to be operated.

### (Supplementary Note 12)

The virtual machine placement determination method according to supplementary note 10, further including generating a prototype of a fault tree by using an undetermined host failure event representing a failure event of a host where it is undetermined that which virtual machine is to be operated.

### (Supplementary Note 13)

The virtual machine placement determination method according to supplementary note 10, further including generating a prototype of a failure/recovery state transition model of the application system by using a failure/recovery state transition model of a host where it is undetermined that which virtual machine is to be operated.

### (Supplementary Note 14)

The virtual machine placement determination method according to any one of supplementary notes 9 to 13, further including: reflecting a configuration of an application on each virtual machine placement proposal to generate a performance model for evaluating performance characteristics of the application; analyzing the performance model to calculate a performance characteristics evaluation value indicating performance characteristics of the application system constructed by each virtual machine placement proposal; calculating an utility value based on the availability evaluation value and the performance characteristics evaluation value by using a utility function; and ranking a virtual machine placement proposal based on the utility value to determine a virtual machine placement proposal applied to the application.

### (Supplementary Note 15)

The virtual machine placement determination method according to any one of supplementary notes 9 to 14, further including: terminating search processing of the virtual machine placement proposal based on a certain condition; and performing the availability evaluation on the virtual machine placement proposal obtained when the search processing is terminated as a target.

### (Supplementary Note 16)

The virtual machine placement determination method according to any one of supplementary notes 9 to 15, further including: terminating evaluation processing of the availability of the application system based on a certain condition; and ranking the virtual machine placement proposal based on an evaluation result obtained at that time.

### (Supplementary Note 17)

A computer program for virtual machine placement determination, the computer program including: a process of searching for a virtual machine placement proposal satisfying a resource limitation to enumerate; a process of reflecting a configuration of an application on each virtual machine placement proposal to generate an availability model for obtaining availability indicating a probability that the application is in an activation state; a process of analyzing the availability model to calculate an availability evaluation value indicating the availability of an application system constructed by the virtual machine placement proposal; and a process of ranking each virtual machine placement proposal based on the availability evaluation value to determine a virtual machine placement proposal applied to the application.

### (Supplementary Note 18)

The computer program for virtual machine placement determination according to supplementary note 17, further including: a process of generating a prototype of the availability model including an undetermined constituent element based on configuration information of the application; and a process of specifying a host for placement a virtual machine based on the virtual machine placement proposal to substitute information relating to the host into the prototype of the availability model.

### (Supplementary Note 19)

The computer program for virtual machine placement determination according to supplementary note 18, further including a process of generating a prototype of a reliability block diagram by using an undetermined host block representing a host where it is undetermined that which virtual machine is to be operated.

### (Supplementary Note 20)

The computer program for virtual machine placement determination according to supplementary note 18, further including a process of generating a prototype of a fault tree by using an undetermined host failure event representing a failure event of a host where it is undetermined that which virtual machine is to be operated.

### (Supplementary Note 21)

The computer program for virtual machine placement determination according to supplementary note 18, further including a process of generating a prototype of a failure/recovery state transition model of the application system by using a failure/recovery state transition model of a host where it is undetermined that which virtual machine is to be operated.

### (Supplementary Note 22)

The computer program for virtual machine placement determination according to any one of supplementary notes 17 to 21, further including: a process of reflecting a configuration of an application on each virtual machine placement proposal to generate a performance model for evaluating performance characteristics of the application, a process of analyzing the performance model to calculate a performance characteristics evaluation value indicating performance characteristics of the application system constructed by each virtual machine placement proposal, and a process of calculating a utility value based on the availability evaluation value and the performance characteristics evaluation value by using a utility function, ranking the virtual machine placement proposal based on the utility value, and determining the virtual machine placement proposal to be applied to the application.

### (Supplementary Note 23)

The computer program for virtual machine placement determination according to any one of supplementary notes 17 to 22, further including a process of terminating search processing of the virtual machine placement proposal based on a certain condition to perform an availability evaluation on a virtual machine placement proposal obtained at that time as a target.

### (Supplementary Note 24)

The computer program for virtual machine placement determination according to any one of supplementary notes 17 to 23, further including a process of terminating evaluation processing of the availability of the application system based on a certain condition to rank a virtual machine placement proposal based on an evaluation result obtained at that time.

Although the present invention is described with reference to the exemplary embodiments and the examples in the above, the present invention is not limited to the above exemplary embodiments and the examples. Various modifications understandable for those skilled in the art can be performed within the scope of the present invention on the configuration and details of the present invention.

This application claims priority based on Japanese Patent Application No. 2013-099492, which was filed on May 9, 2013, the entire disclosure of which is incorporated herein.

### REFERENCE SIGNS LIST

1, 101 Virtual machine placement proposal search unit
2, 102 Availability model synthesizing unit
3, 103 Application availability evaluation unit
4, 104 Virtual machine placement ranking unit
5, 121 Performance model synthesizing unit
6, 122 Application performance evaluation unit
7, 131 Search terminating unit
8, 132 Evaluation terminating unit
21, 112 Availability model prototype generating unit
22, 114 Placement host substitution unit
100, 200, 300 Virtual machine placement determination device
105 Resource limitation storage unit
106 Application configuration information storage unit
107 Availability evaluation parameter storage unit
111 Application configuration information acquisition unit
113 Availability model prototype storage unit
123 Performance evaluation parameter storage unit
   124 Utility function storage unit

What is claimed is:

1. A virtual machine placement determination device comprising:
a virtual machine placement proposal search unit configured to search for a virtual machine placement proposal satisfying a resource limitation to enumerate;
an availability model synthesizing unit configured to generate an availability model for each virtual machine placement proposal, the availability model being described by at least one of a block diagram showing a configuration of an application, a logical expression indicating a combination of failure events of the application, and a probability process indicating a state transition of the application, and being used in a calculation of availability indicating a probability that the application is in an activation state;
an application availability evaluation unit configured to analyze the availability model to calculate an availability evaluation value indicating the availability of an application system constructed by the virtual machine placement proposal; and
a virtual machine placement ranking unit configured to rank each virtual machine placement proposal based on the availability evaluation value to determine the virtual machine placement proposal applied to the application.

2. The virtual machine placement determination device according to claim 1, wherein the availability model synthesizing unit includes
an availability model prototype generating unit configured to generate a prototype of the availability model including an undetermined constituent element based on configuration information of the application, and
a placement host substitution unit configured to specify a host for placement a virtual machine based on the virtual machine placement proposal to substitute information relating to the host into the prototype of the availability model.

3. The virtual machine placement determination device according to claim 2, wherein the availability model prototype generating unit generates a prototype of a reliability block diagram by using an undetermined host block representing a host where it is undetermined that which virtual machine is to be operated.

4. The virtual machine placement determination device according to claim 2, wherein the availability model prototype generating unit generates a prototype of a fault tree by using an undetermined host failure event representing a failure event of a host where it is undetermined that which virtual machine is to be operated.

5. The virtual machine placement determination device according to claim 2, wherein the availability model prototype generating unit generates a prototype of a failure/recovery state transition model of the application system by using a failure/recovery state transition model of a host where it is undetermined that which virtual machine is to be operated.

6. The virtual machine placement determination device according to claim 1, further comprising:
a performance model synthesizing unit configured to reflect a configuration of an application on each virtual machine placement proposal to generate a performance model for evaluating performance characteristics of the application; and
an application performance evaluation unit configured to analyze the performance model to calculate a performance characteristics evaluation value indicating performance characteristics of the application system constructed by each virtual machine placement proposal,
wherein the virtual machine placement ranking unit calculates a utility value from the availability evaluation value and the performance characteristics evaluation value by using a utility function, ranks the virtual machine placement proposal based on the utility value, and determines the virtual machine placement proposal to be applied to the application.

7. The virtual machine placement determination device according to any one of claim 1, further comprising a search terminating unit configured to terminate search processing in the virtual machine placement proposal search unit based on a certain condition,
wherein the application availability evaluation unit performs the availability evaluation on the virtual machine placement proposal obtained when the search processing is terminated as a target.

8. The virtual machine placement determination device according to any one of claim 1, further comprising an evaluation terminating unit configured to terminate evaluation processing in the application availability evaluation unit based on a certain condition,
wherein the virtual machine placement ranking unit ranks a virtual machine placement proposal based on an evaluation result obtained when the evaluation processing is terminated.

9. A virtual machine placement determination method comprising:
searching for a virtual machine placement proposal satisfying a resource limitation to enumerate;
generating an availability model for each virtual machine placement proposal, the availability model being described by at least one of a block diagram showing a configuration of an application, a logical expression indicating a combination of failure events of the application, and a probability process indicating a state transition of the application, and being used in a calculation of availability indicating a probability that the application is in an activation state;
analyzing the availability model to calculate an availability evaluation value indicating the availability of an application system constructed by the virtual machine placement proposal; and
ranking each virtual machine placement proposal based on the availability evaluation value to determine a virtual machine placement proposal applied to the application.

10. A non-transitory computer readable information recording medium storing a virtual machine placement determination program, when executed by a processor, that performs a method for:
searching for a virtual machine placement proposal satisfying a resource limitation to enumerate;
generating an availability model for each virtual machine placement proposal, the availability model being described by at least one of a block diagram showing a configuration of an application, a logical expression indicating a combination of failure events of the application, and a probability process indicating a state transition of the application, and being used in a calculation of availability indicating a probability that the application is in an activation state;
analyzing the availability model to calculate an availability evaluation value indicating the availability of an application system constructed by the virtual machine placement proposal; and
ranking each virtual machine placement proposal based on the availability evaluation value to determine a virtual machine placement proposal applied to the application.
